(19) United States
(12) Patent Application Publication
(10) Pub. No.: US 2012/0141645 A1
(43) Pub. Date: Jun. 7, 2012

(54) METHOD AND SYSTEM FOR NON DESTRUCTIVE LEAN RECOVERY

(75) Inventors: Jason W. Tomcak, Jefferson, SD (US); Brad J. Dirkschneider, Sioux City, IA (US)

(73) Assignee: TYSON FOODS, INC., Springdale, AR (US)

(21) Appl. No.: 12/958,377

(22) Filed: Dec. 1, 2010

(51) Int. Cl. A23L 1/317; B03B 5/28

(52) U.S. Cl. 426/480; 99/536

(57) ABSTRACT

An apparatus and method for a non-destructive lean recovery operable for separating lean and fat animal tissue in sparse lean products, such as for example, meat trimmings. The method and apparatus exploits the fact that lean and fatty tissue have distinctly different specific gravities. The method and apparatus impacts the sparse lean material with a force, which breaks the lean material into small pieces of fat and lean material thereby separating the fat portions from the lean portions. The sparse lean material can be initially ground through a grind plate and the ground material can be suspended in a water bath and agitated with sufficient force to separate the fat from the lean material. As the forces are applied and the separation occurs, due to the different specific gravities of the lean and fat, the fat will tend to float to the surface of the water bath and the lean material will tend to sink in the water bath, thereby facilitating recovering the lean material portions.

### BACKGROUND OF INVENTION

1. Field of Invention

This invention relates generally to sparse lean processing and, more particularly, to separating fat from lean in a sparse lean.

2. Background Art

Attention within the meat industry has been recently drawn to the dangers of diets high in fat, especially as high fat diets have been implicated in an increased incidence of diseases of blood vessels, such as coronary heart disease and arteriosclerosis. As a consequence, the medical profession has suggested that the consumption of fat should be reduced. One way to accomplish this is to eat meats that have been processed so that they contain a reduced amount of fat.

One method to reduce the amount of fat in meat is simply to manually cut fat from the meat. Meat having higher amounts of fat is cut or trimmed from meat having lower amount of fat (meat that is more lean). The resulting trimmings are merely separated by operators with sharp cutting utensils. However, manually cutting more fatty portion from the more lean portions, for example, is not effective in reducing the fat content of the remaining more lean portions to lower than about five percent. In addition, this process does not assist in recovering any further lower fat lean portions from the trimmings. Further, skilled workers and time are required to cut the meat, thus making the process expensive and inefficient, further necessitating the need to recover usable lean from the trimmings. Further, the trimmings or sparse lean is now an undesired portion of the primal cut and it is not economical to make the sparse lean into a ground product due to its high fat content. Without further processing to remove fat, the product would be sold as low value rendered product.

In an attempt to reduce the fat content of meat and meat trimmings other processes have been proposed and utilized. These processes typically employ one or more of the following approaches. First, the fat can be freed from meat by mechanical techniques, such as by the use of a grinder, a crusher, a press, a comminutor, or a micro-comminutor. These procedures have been employed with or without accompanying high temperatures. Physical extraction techniques have also been utilized, such as the use of heat, and reaction of gases with meats, including fluid extraction. Fat has also been removed employing chemical extraction techniques, such as the use of chemical reagents, including acids.

Unfortunately, these techniques generally have a detrimental impact on the meat or alter the meat's protein profile, vitamin profile, color, texture and/or water content. For example, high temperatures denature meat. The use of diluents, such as water, can leach water-soluble proteins and vitamins from the meat and can increase the moisture content of the defatted product. Additionally, when diluents are used with micro-comminution of meat, the functional properties of the resulting product can be adversely affected. The use of chemical reagents, acid or alkaline treatment of meat facilitates the binding of anions or cations, respectively, to the protein, thereby adversely affecting the meat's properties.

Moreover, it is often the subsequent separation step that is critical to the success or failure of a defatting process. Even if a substantial amount of fat is initially liberated from the meat, unless the fat is effectively separated from the meat, the process will not be a success. For example, even if the proper choice of conditions for grinding or comminuting meat produces a substantial fat-containing fraction, conventional devices, such as conventional decanter centrifuges, are not completely effective in separating the resulting fractions.

Decanter centrifuge methods have also been utilized for producing lower fat lean meat having substantially the same functionality, protein profile, vitamin profile, color, texture and water content as the raw meat starting material. The reduced fat meat, however, can often contain from about 0% to 10% fat and can have a substantially reduced level of cholesterol. The decanter centrifuge can have a hollow, centrifugal rotor with a longitudinal axis of rotation a. The centrifugal rotor defines a generally cylindrical bowl tapered at one end to form a beach. The centrifuge also can have a feed tube for introducing starting material into a delivery zone in the interior of the cylindrical bowl and a fluid inlet tube for proportionately metering a fluid into the feed tube. A screw conveyor, can be disposed in the cylindrical bowl to cause a substantially solid portions to be discharged out of at least one solid discharge port located at the tapered end of the rotor and a substantially liquid fraction to be discharged out of at least one liquid discharge port located at the opposing end of the rotor.

Further, Low temperature rendering processes have been used to separate protein from fatty tissue in animal trimmings. The processes generally involve comminuting fatty tissue from animals, such as hogs or cattle, to form a semi-solid slurry or meat emulsion, heating the slurry or emulsion to melt the fat, and then separating the fat and protein by centrifugation. The protein can then be used as an ingredient in processed meat products such as sausage and other cured and processed meats. It has been found that the protein or meat provided by prior art low temperature rendering processes suffer from undesirable flavor changes shortly after production. In order to reduce the flavor changes after low temperature rendering processes, some process use a conditioning agents which reacts or combines with the pigments of the meat to reduce the activity of the pigments which catalyzes the development of off-flavor.

The government provides that a certain quality of meat product obtained from animal trimmings can be used undeclared in meat products of the same species. For example, “finely textured beef” and “lean finely textured beef” can be used in ground beef without being declared on the label. “Finely textured meat” is required to have a fat content of less than a defined percent; a protein content of greater than a defined percent. “Lean finely textured meat” is required to have a fat content of less than a defined percent, by weight, and complies with the other requirements of “finely textured meat.”

A low temperature rendering process can include the process steps of: heating desinewed animal trimmings in a heat exchanger having a first-in and first-out arrangement to provide heating of the desinewed animal trimmings to a temperature in the range of about 90.degree. F. to about 120.degree. F. to form a heated slurry; separating a solids stream and a liquids stream from the heated slurry, the solids stream containing an increased weight percent of protein and moisture compared with the weight percent of protein and moisture in the heated slurry, and the liquids stream containing an increased weight percent of tallow compared with the weight percent of tallow in the heated slurry; separating a heavy phase and a light phase from the liquids stream, the heavy phase containing an increased weight percent of moisture and water soluble protein compared with the weight percent of moisture and water soluble protein in the liquids stream, and the light phase containing an increased weight percent of tallow compared with the weight percent of tallow in the liquids stream; and combining the solids stream and the heavy phase to form a meat product. Preferably, the meat product has a fat content of less than 30%; a protein content of greater than 14%; and a protein efficiency ratio of 2.5 or higher, and an essential amino acids content of at least 33% of the total amino acids. In a preferred embodiment, the animal trimmings are processed in closed environment so that atmospheric oxidation is reduced. In addition, the animal trimmings are preferably not heated above 110.degree. F. in the heat exchanger, and are not treated with chemicals or additives.

The step of separating a solids stream and a liquids stream from the heated slurry can occur in a decanter, and the step of separating a heavy phase and a light phase from the liquids stream can occur in a centrifuge, and the meat product can be frozen within about 30 minutes of heating the desinewed animal trimmings in a heat exchanger. The meat product prepared by the low temperature rendering process is preferably finely textured meat. Preferably, the low temperature rendering process is continuous, but can be modified for batch or semi-batch operations. However, even at the temperature levels of these so-called low temperature processes, microbial growth is likely to occur and the appearance and texture of the lean material will likely be negatively impacted. Therefore, a better process is needed.

### BRIEF SUMMARY OF INVENTION

The invention is a non-destructive lean recovery apparatus and method for separating lean and fat animal tissue in sparse lean products, such as for example, meat trimmings. The invention exploits the fact that lean and fatty tissue have distinctly different specific gravities. The invention impacts the sparse lean material with a force, which breaks the lean material into small pieces of fat and lean material thereby separating the fat portions from the lean portions. The sparse lean material can be initially ground through a grind plate and the ground material can be suspended in a water bath and agitated with sufficient force to separate the fat from the lean material. Other means of force applied in the water bath can be utilized such as for example forces applied by compress air or mechanical forces applied by blades. As the forces are applied and the separation occurs, due to the different specific gravities of the lean and fat, the fat will tend to float to the surface of the water bath and the lean material will tend to sink in the water bath. More specifically, material having a percent lean greater than about approximately 70% will tend to sink in the water bath whereas the more fatty material will tend to float on the top. The term sparse lean is used throughout, however, any type of lean starting material can be used.

One embodiment of the invention can include, a grind plate that is about approximately ⅜ inch (other sizes can be utilized for greatest efficacy, which may vary depending on the source and type of mater being process), a water bath having an agitation or force inducing mechanism (for example a rotating blade, though other means of agitation can be utilized), a settling basin where the agitated material will flow and where the fat can float and the lean can sink below the surface, a fresh water flow mechanism or a mechanical skimmer (for example a skimming conveyor) operable to remove the fatty material from the top of the settling basin, a second fresh water flow mechanism or other mechanical traversing or transport mechanism (for example a conveyor or an auger) operable to remove the lean from the bottom of the settling basin, and a centrifuge or press operable to remove water from the separated lean material for further processing.

The temperature of the water can be about approximately 40 degrees Fahrenheit, which has an advantage over the typical heated centrifuge processes that attempt to liquefy the fat for separation, but have problems with microbial growth and problems that impact the appearance, characteristics and texture of the product. The appearance, characteristics and texture of the product utilizing the present invention is un-altered, particularly when operated at desired water temperatures, which can vary from about approximately 35 degrees Fahrenheit to about approximately 50 degrees Fahrenheit. Further, the removal of water from the separated lean material reduces any issues resulting from excess water.

Another embodiment of the invention is a method for recovery of lean from sparse lean including suspending sparse lean in water in a vessel having an agitator within said vessel and adapted to apply agitation forces to said sparse lean where said agitation forces provide sufficient impact forces to separate lean material portions from fat portions of the sparse lean by agitating the sparse lean with the agitator. A fresh water flow can be utilized to flow the separated lean material portions and the fat portions from the vessel into a settling basin and suspending the lean material portions and the fat portions in water in the settling basin. The lean material portions can be allowed to sink below the surface of the water contained in the basin and the fat portions can be allowed to float toward the top of the water contained in the basin. The floating fat portions floating toward the top of the water contained in the settling basin can be skimmed off and captured for further processing. The lean material portions sunk below the surface of the water contained in the settling basin can be removed by channeling through an exit port and captured for further processing. The agitator can be for example a rotating propeller blade or a compressed air jet. The step of skimming can be performed by skimming flaps projecting from an endless conveyor over the surface of the water in the settling basin. The method can further comprise the step of removing water from the lean material portions using a centrifuge. The water in said vessel and in said settling basin is maintained at a temperature from 35 degrees Fahrenheit to 50 degrees Fahrenheit in order to facilitate separation of the lean material portion and the fatty portions and to reduce microbial growth.

An alternative embodiment of the present invention includes an optional grinder pump and centrifuge combination in addition to or in lieu of the agitator of the present invention. The grinder and pump combination will output a slurry, which can be sent through a centrifuge or cyclone to further separate the lean from the fat.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is a perspective view of a lean recovery system;

FIG. 2 is a front perspective view of the lean recovery system;

FIG. 3 is a left side perspective view of the lean recovery system;

FIG. 4 is a rear perspective view of the lean recovery system;

FIG. 5 is a top perspective view of the lean recovery system;

FIG. 6 is a right side perspective view of the lean recovery system;

FIG. 7 is a perspective view of the agitation vessel and settling basin combination;

FIG. 7A is a perspective view of settling basin side walls and auger trough;

FIG. 8 is a perspective view of the agitation vessel;

FIG. 9 is a perspective view of the agitation vessel;

FIG. 10 is a perspective view of the agitation vessel;

FIG. 10A is a section view illustrating product flow;

FIG. 11 is a front perspective view of the lean material portion exit conveyor;

FIG. 12 is a rear perspective view of the lean material portion exit conveyor; an

FIG. 13 is a perspective view of the centrifuge dryer;

FIG. 14 is a non-thermal process flow with sorting tank; and

FIG. 15 is a non-thermal process flow with the optional centrifuge/cyclone.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF INVENTION

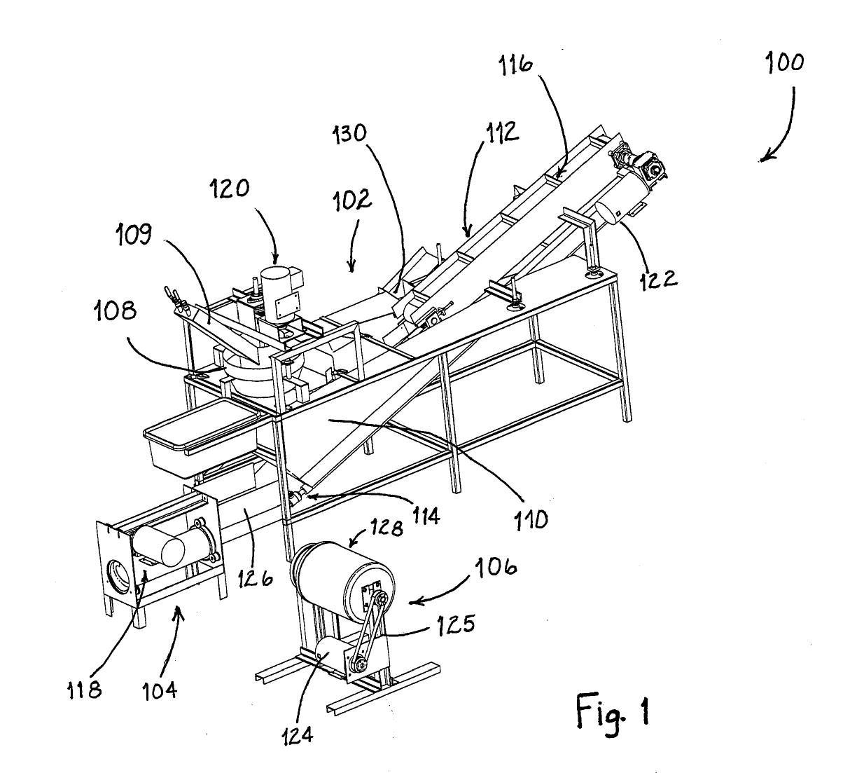

According to the embodiment(s) of the present invention, various views are illustrated in FIG. 1-13 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present invention comprising a grind plate that is about approximately ⅜ inch (other sizes can be utilized for greatest efficacy, which may vary depending on the source and type of mater being process), a water bath having an agitation or force inducing mechanism (for example a rotating blade, though other means of agitation can be utilized), a settling basin where the agitated material will flow and where the fat can float and the lean can sink below the surface, a fresh water flow mechanism or a mechanical skimmer (for example a skimming conveyor) operable to remove the fatty material from the top of the settling basin, a second fresh water flow mechanism or other mechanical traversing or transport mechanism (for example a conveyor or an auger) operable to remove the lean from the bottom of the settling basin, and a centrifuge or press operable to remove water from the separated lean material for further processing, teaches a novel apparatus and method for recovering lean from trimmings and the like in a non-destructive manner.

The details of the invention and various embodiments can be better understood by referring to the figures of the drawing. Referring to FIG. 1, a perspective view of a lean recovery system 100 is shown. The lean recovery system 100 has three (3) major subsystems and they are: the separator system 102, the lean material portion conveyor (auger) 104 and the water extraction system 106. The separator system 102 includes an agitator assembly which further comprises a capture vessel (pan) 108, a sparse lean product chute 109 and an agitator duct 206. The agitator assembly further includes an agitator motor 120 which provides the drive means for the agitator.

The sparse lean product can be input into the agitator assembly by inputting and channeling the sparse lean product down the product chute 109. The sparse lean product will travel down the chute 109 into the agitator duct 206. The parse lean product can be manually deposited in the chute 109 or alternatively the sparse lean product can be automatically dropped on the chute 109 by way of a conveyance system. When the sparse lean product travels down the product chute 109 into the agitator duct 206, the sparse lean product will encounter an agitator within the duct 206, which will apply an impact force having sufficient force to separate the lean material portions of the parse lean product from the fatty portions. The agitator duct and surrounding capture vessel 108 is continuously being filled with water such that the water will overflow the capture vessel into the settling basin 110.

The agitator will force the product through the agitator duct and into the capture vessel 108 and the continuous water flow will cause the separated product to travel along with the overflow of water into the settling basin 110. Once in the settling basin 110, the separated lean material portions of the sparse lean product will tend to sink toward the bottom of the settling basin which is filled with water. The separated fatty portions of the parse lean product will tend to float toward the top of the water contained within the settling basin 110. The fatty portion can be skimmed off by the skimming conveyor system 112 or other skimming mechanism, for example a mechanical arm that skims the surface of the water with a sweeping motion. The fat can also or alternatively be allowed to flow thru the overflow channel 130 and dewatered with a similar device as 104 thereby, eliminating the need for a skimming conveyor.

The skimming conveyor system can include a conveyor motor, which drives an endless conveyor belt having conveyor belt flaps extending there from. As the flaps are conveyed along the bottom run of the endless belt, the flaps will skim off any floating fatty portions thereby removing them from the settling basin. The settling basin can also include an overflow drain channel 130 such that any water overflowing the settling basin can be channeled there through. The drain channel 130 can also export any fatty material not captured by the skimming conveyor system 112.

The lean material portion conveyor 104 can include an auger and an auger screen 118. Lean material portions can be channeled through the exit port 114 into the water velocity reducer 126 and further directed into the auger and auger screen 118. Once the lean material portions have been conveyed through the auger, the lean material portions can be captured manually or automatically conveyed to be inserted in the water extraction system 106. The water extraction system can include a centrifuge motor and centrifuge drive belt for turning the interior drum of the centrifuge within the centrifuge outer drum 128.

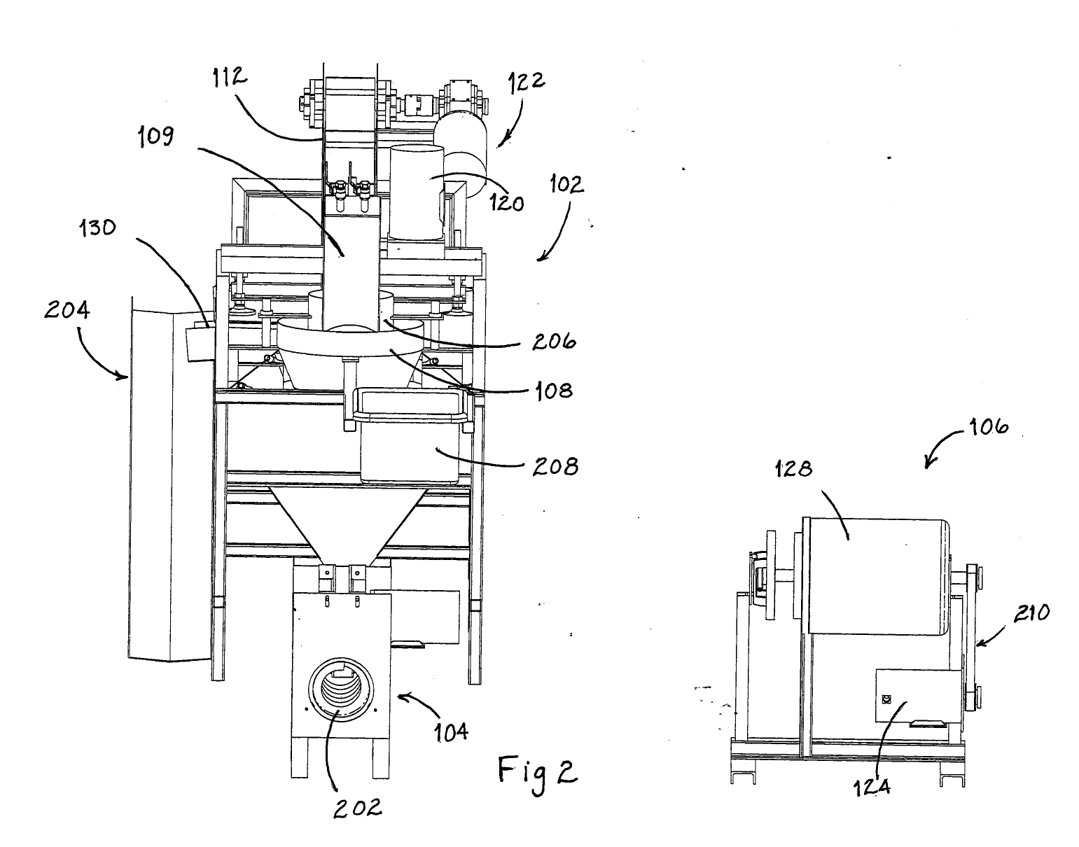

Referring to FIG. 2, a front perspective view of the lean recovery system 100 is shown. This view reveals the auger helix 202, which is one embodiment that can be utilized to convey lean material portions from the settling basin for further processing. This view also reveals a secondary chute 204 for which can receive water and any fatty material received from the settling basin overflow drain channel 130. This view also provides a different perspective of the parse lean product chute 109 down which product flows into the agitator duct 206. Within this agitator duct 206 an agitator provides a sufficient impact to the parse lean product such that the lean material portions are separated from the fatty portions. This view also shows a different perspective of the water extraction system 106 having a centrifuge motor 124 and a centrifuge drive belt 210 for rotating the interior centrifuge drum.

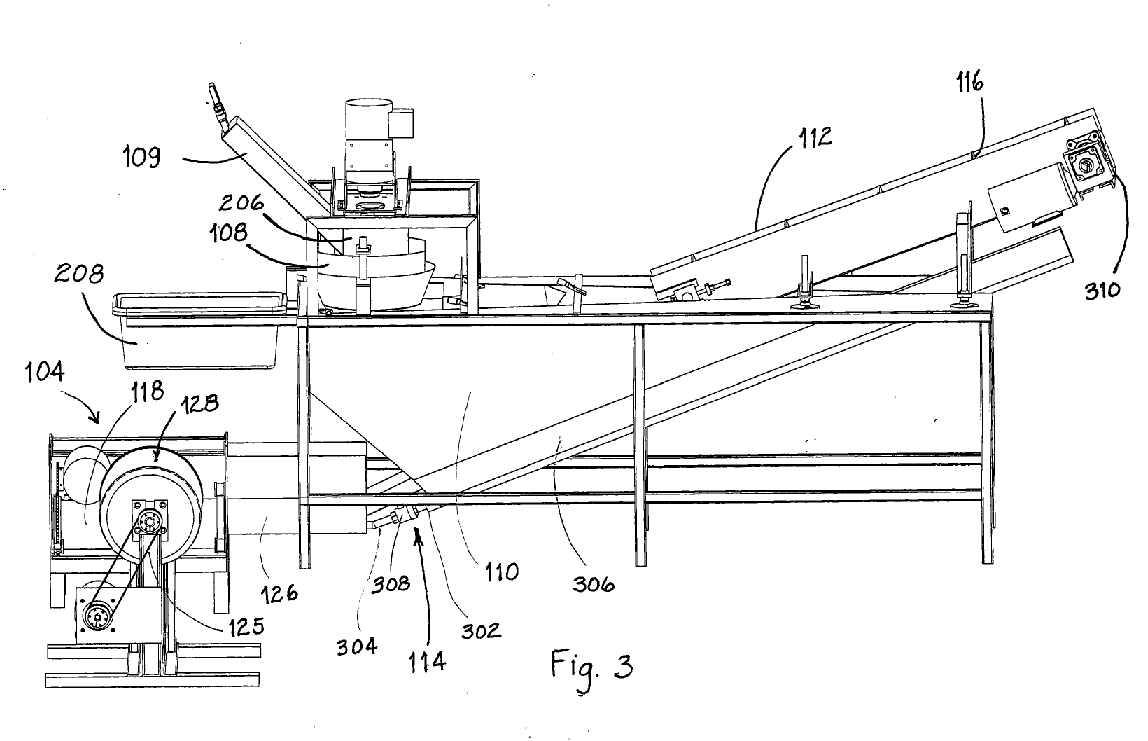

Referring to FIG. 3, a left side perspective view of the lean recovery system 100 is shown. This view shows a side perspective of the settling basin 110 which has on its lower end a lean material portion channeling trough 306. The settling basin 110 can be filled with water for receiving and suspending the separated material overflowing from the agitator assembly. The lean material portions will have a tendency to sink in the water and ultimately settle in the lean material portion channeling trough 306. The lean material portions will tend to travel down the downward slope of the trough 306 and will be urged through the lean material portion output flange 302. This urging down slope of the trough can be simply achieved by gravitational forces or can be urged along by an air jet or other urging means. The one embodiment shown uses gravity and an additional water input at the upper end of the trough to urge the product along.

The lean material portions can travel through the lean material portion exit port 114 when the lean material portion exit valve 308 is opened. The lean material portions can continue through the discharge pipe 304 and further into the water velocity reducer 126 of the lean material portion conveyor 104. The lean material portions can be channeled through the water velocity reducer 126 and into the auger 104. Then auger helix 202 can convey the lean material portions through the conveyor and the auger screen 118 will allow any excess water to drip from the lean material portions. This side perspective also shows the skimming conveyor system 112 having a fatty material discharge end 310 where the conveyor belt flaps 116 can push any fatty material captured by the conveyor through the discharge end 310. Lean material portions exiting the conveyor 104 can then be input into the water extraction system 106. This can be accomplished by manually feeding the separated lean material portions into the centrifuge or automatically inputting the separated lean material portions into the centrifuge by way of a conveyance system (not shown). Lean product could be transported using a screw or belt conveyor to 106 or 104 could be eliminated and water/lean discharge could be transferred to a decanter through a flume where the decanter would do the complete separation of water and solid lean portions.

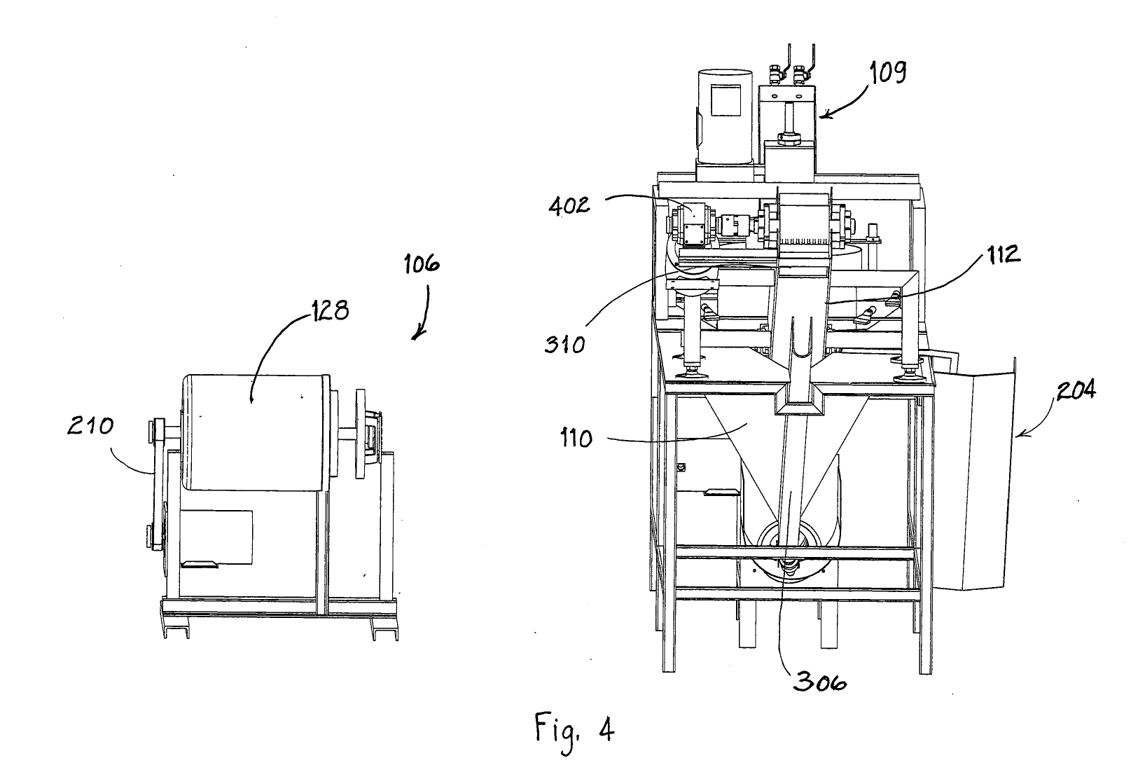

Referring to FIG. 4, a rear perspective view of the lean recovery system 100 is shown. This view provides a better perspective of the fatty material discharge in 310 through which fatty material captured can be discharged onto a separate conveyor system (not shown) for further processing. This view also reveals the conveyor drive gear 402 connected between the conveyor motor 122 and the conveyor 112. This view also shows the channeling trough 306 extending along the keel of the settling basin 110. This view also shows the centrifuge cover slightly opened for receipt of lean material portions for removal of excess water.

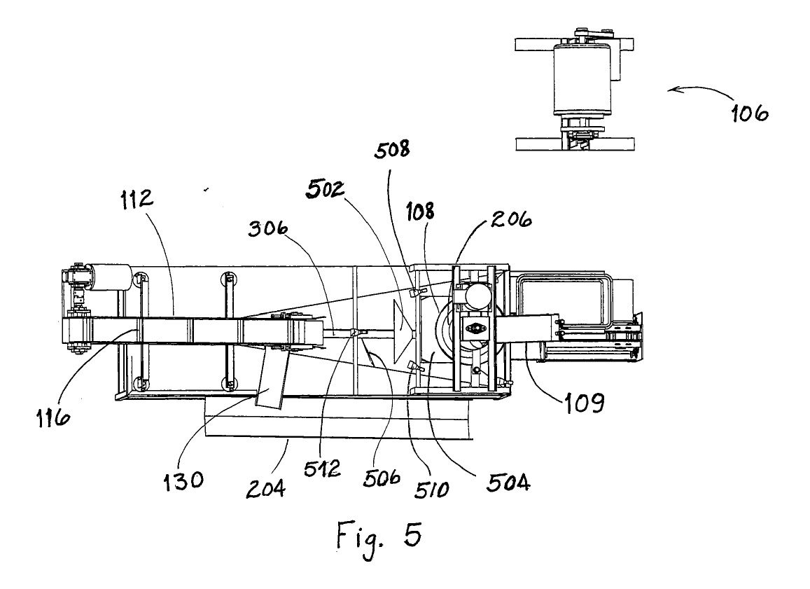

Referring to FIG. 5, a top perspective view of the lean recovery system 100 is shown. This view reveals a funnel baffle 502 which can be utilized to funnel lean material portions that are sinking in the water down toward the channeling trough 306 and also toward the lean material exit port 114. The agitator overflow baffle 504 is utilized to baffle the material overflowing from agitator. The settling basin also has an additional fatty material baffle 506 which can channel any floating fatty material towards the skimming conveyor system 112. Please note that items 508, 510 and 512 can be included and which represent air jets which can be utilized to direct the flow of the separated material.

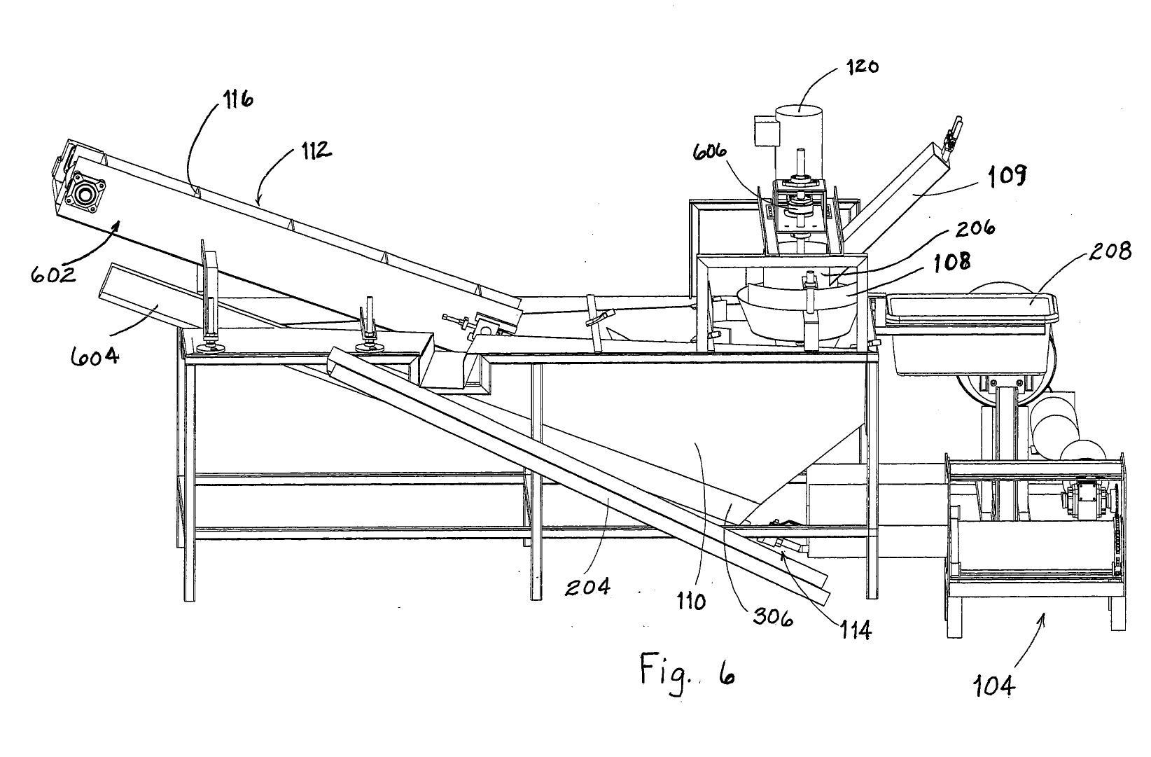

Referring to FIG. 6, a right side perspective view of the lean recovery system 100 is shown. This side view provides a view of the conveyor under shroud 602 through which the conveyor conveys fatty material which has been skimmed from the surface of the water in the settling basin. This view also shows an upper extension or upper trough portion 604. Air jets, fluid flow nozzles or other urging means can be directed downward along the upper extension or upper trough, which can be utilized to urge material to flow down through the channeling trough 306. This view also shows the motor drive 120 for the agitator and the agitator drive belt 606 which is utilized to cause rotation of the agitator blades.

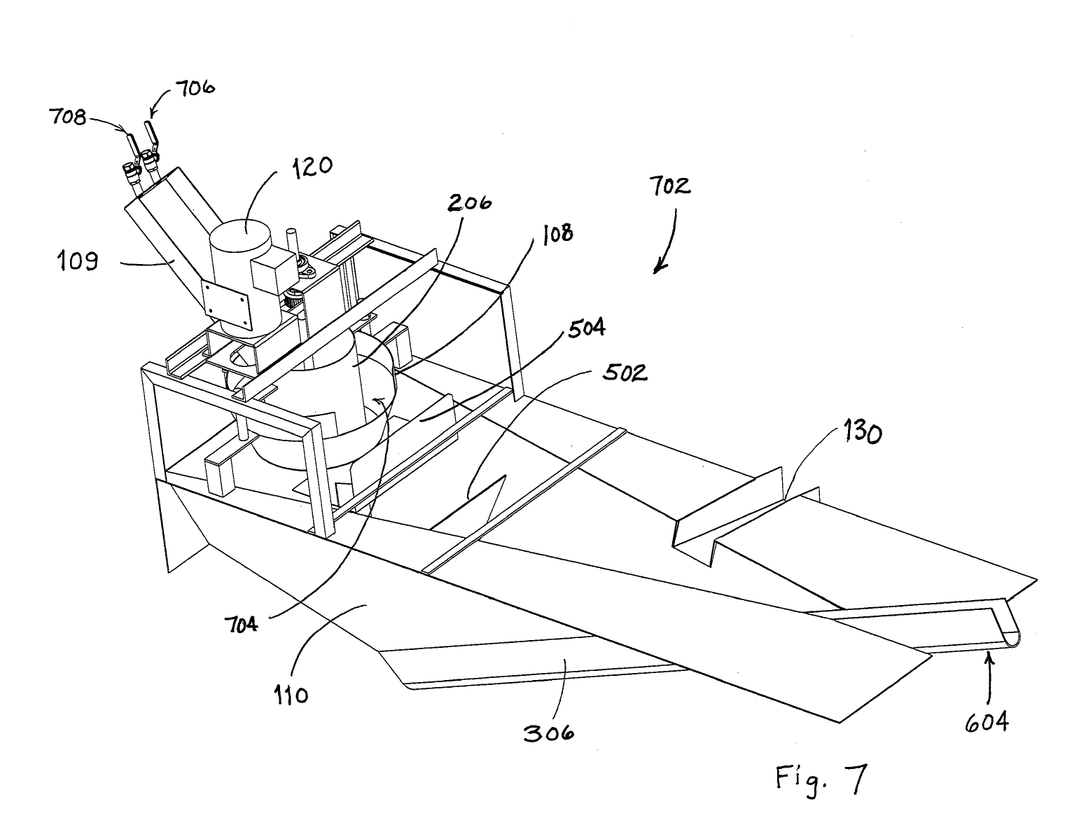

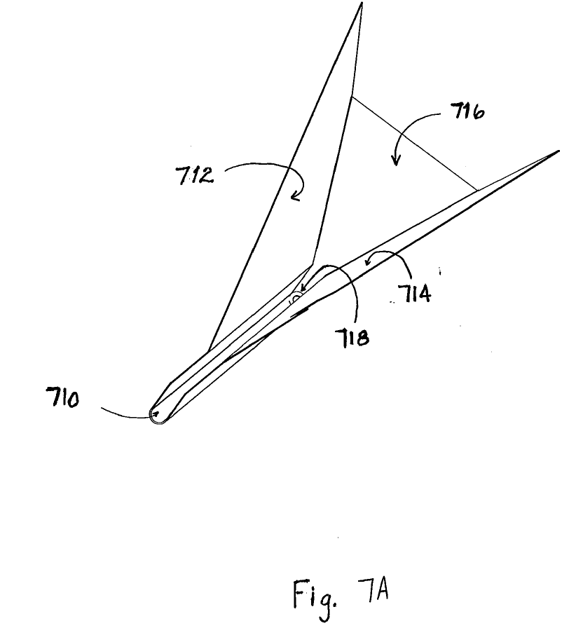

Referring to FIG. 7, a perspective view of the agitation vessel and settling basin combination 702 is shown. Item 704 reflects an agitator overflow opening through which separated material can flow into the settling basin. This view also reveals product chute water valves 706 and 708 which can be utilized to turn on a water stream to urge product down the chute and in it the agitation assembly. The water source controlled by the use valves 706 and 708 can be the primary water source for the system. A further view of the baffles 502 and 504 are shown further. The baffle 504 can break the speed of travel of the material falling from the agitator such that the distance for which the material falls is shortened. The system can work without baffles 502 and 504 and/or the pan 508.

The top of the baffle 502 can be beneath the surface of the water which is filled to the rim of the settling basin such that the separated fatty material floating approximate the surface of the water and can travel over the funnel baffle 502. Lean material portions that have sunk beneath the top edge of the funnel baffle 502 will be directed downward toward the lean material portion output port 718. Item 710 shows the opening of the trough 710. The settling basin has slatted side walls 712 and 714 which will channel sinking lean material portions downward toward the trough and further toward the lean material output port. The funnel baffle 716 will urge the material downward in a similar manner.

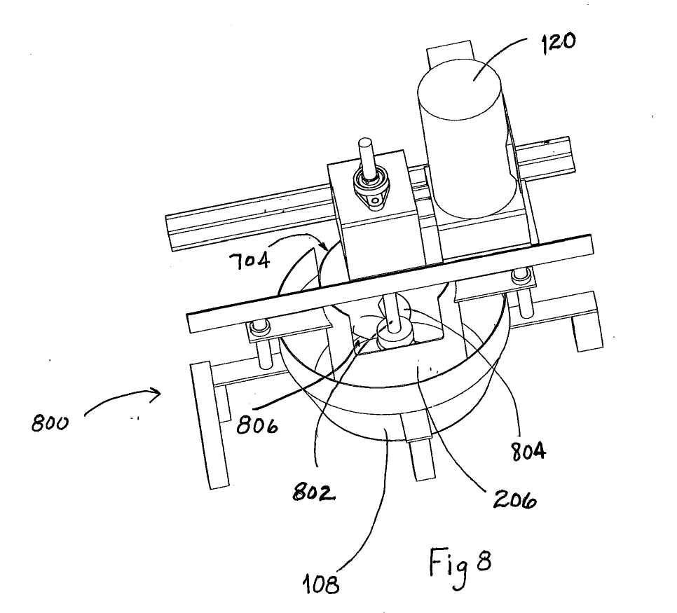

Referring to FIG. 8, a perspective view of the agitation vessel 800 is shown. The agitation vessel can include a capture vessel or pan 108 which receives separated material that has undergone engagement and impact with the agitator. This further includes and agitator duct 206 which contains the lean sparse material in a confined area such that engagement and impact with the rotatable agitator blade 804 is enhanced. Sparse lean material will travel down the product chute and through the product chute duct opening 806 and into the duct. The duct confines the product within a volume proximate the agitator to increase engagement and effectiveness of the agitator. The agitator can be a rotatable agitator blade 804 or fluid jets or other agitation means. For example, rotating paddles or a combination of rotating and fixed paddles can be utilized. The opening between the agitator pan 108 and the agitator duct 206 also creates the dwell time that product is within the agitator duct. The smaller the gap, the more dwell time product is within the agitator duct. If as an alternative the pan 108 were eliminated, then a gate could be added at the bottom of the agitator duct to limit the opening and create the necessary dwell time.

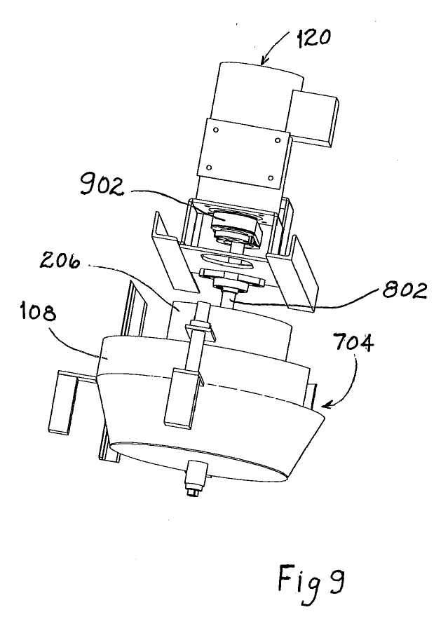

Referring to FIG. 9, another perspective view of the agitation vessel is shown. Agitator motor is shown driving a drive belt 902 which is transferred to the rotatable agitator axle 802.

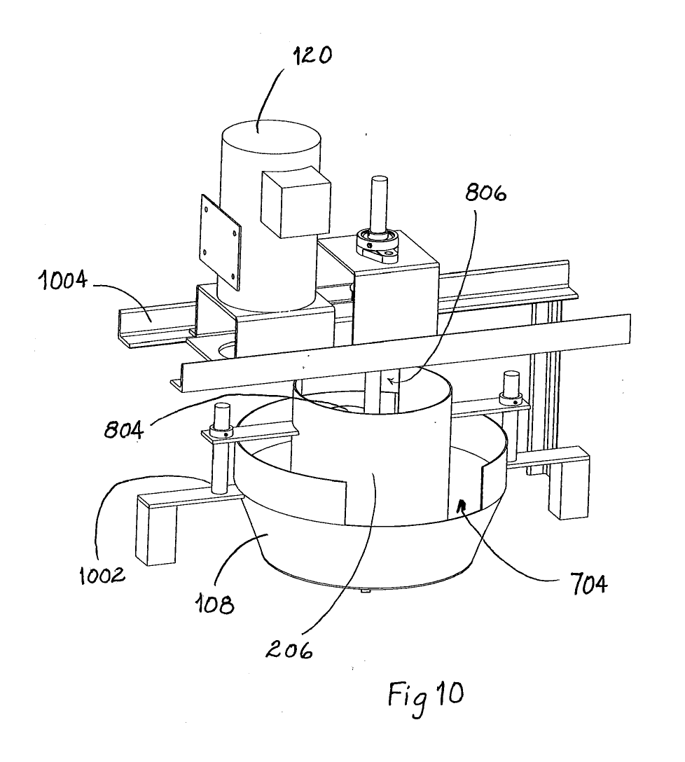

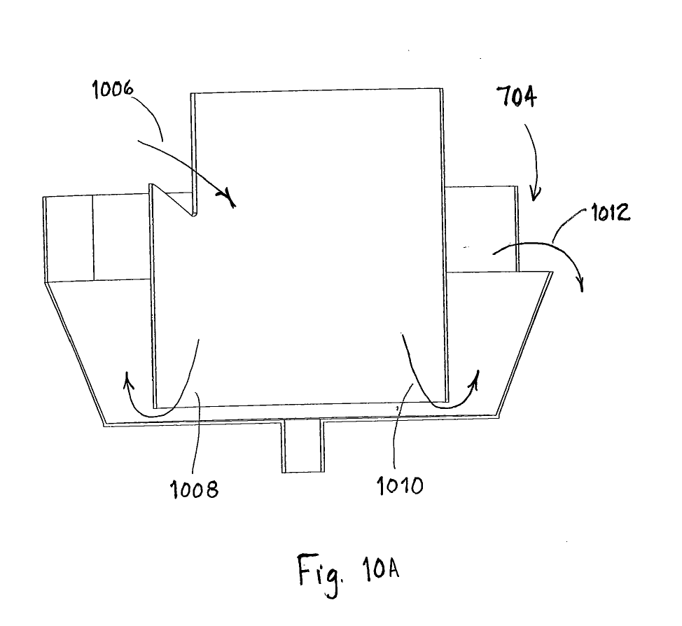

Referring to FIG. 10, a perspective view of the agitator assembly is shown. Again the agitator assembly includes an agitator duct 206 which contains sparse lean product within a constrained area to induce engagement with the agitation device 804. Once the material has traveled downward through the agitator it will flow into the capture vessel 108 and as the capture vessel fills or it will overflow and material will outflow through the agitator overflow opening 704. FIG. 10-A shows in illustration of the sparse lean product as it travels through the chute and into the duct as illustrated by the directional arrow 1006. The material will travel downward through the agitation device and flow into the capture vessel 108 as shown by directional arrows 1008 and 1010. As the capture vessel 108 fills water and separated material will travel out through the agitator overflow opening 704 as indicated by directional arrow 1012.

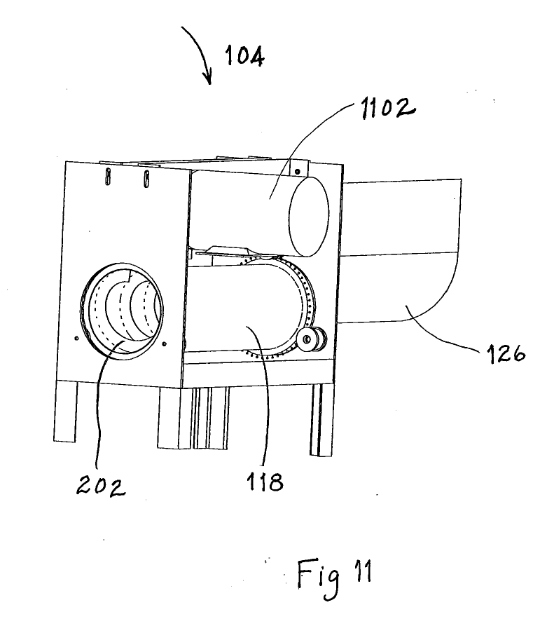

Referring to FIG. 11, a front perspective view of the lean material portion exit conveyor 104 is shown. Again the exit conveyor 104 includes a water velocity reducer 126 which received separated material exiting the settling basin. The auger helix 202 will convey the separated lean material portion away from the settling basin and any excess water will flow through the auger screen 118. The auger can be powered by a motor 1102 which will turn the auger helix 202.

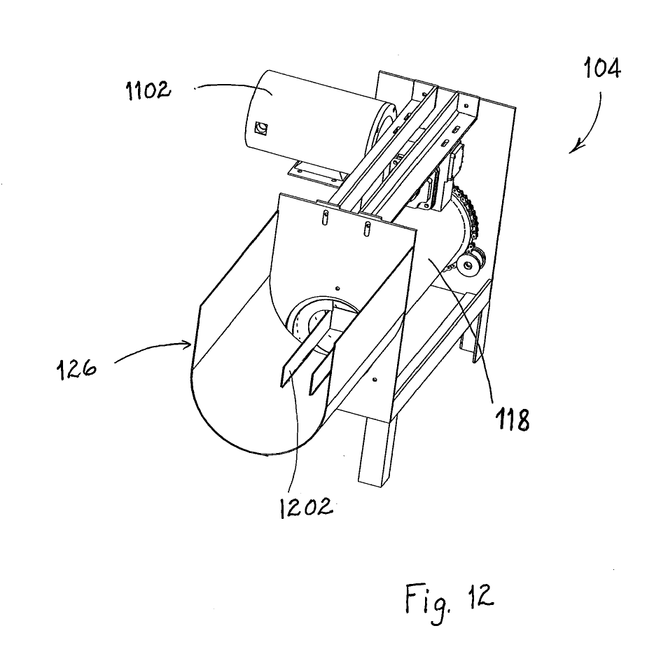

Referring to FIG. 12, a rear perspective view of the conveyor 104 is shown. The water velocity reducer 126 is shown having water diverters 1202 which will channel the lean material portions into the auger helix 202.

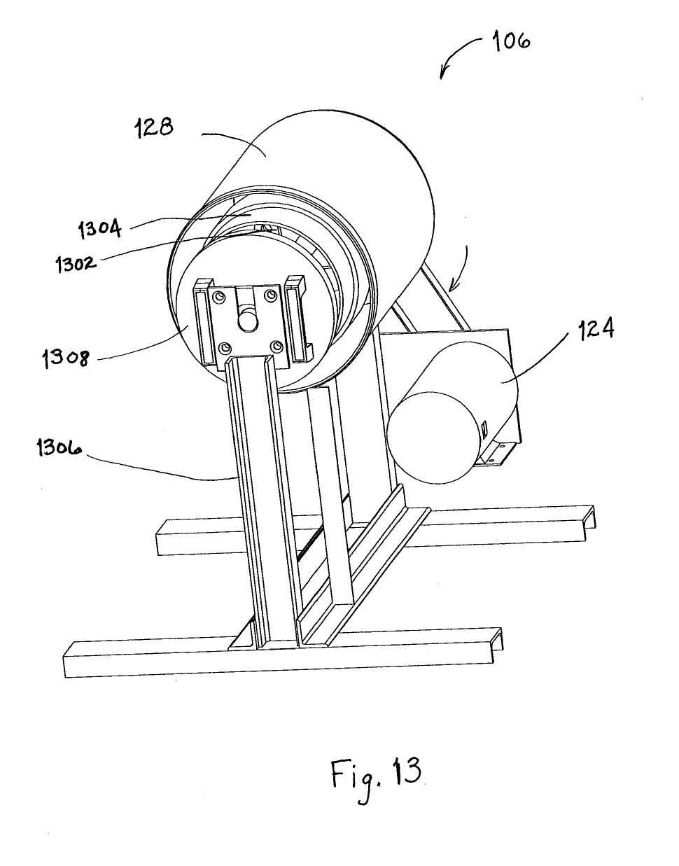

Referring to FIG. 13, the water extraction system 106 is shown. The extraction system is shown as a centrifuge device having a centrifuge drive motor 124 which powers a centrifuge drive belt 125 which transfers power to the centrifuge interior drum 1304 causing rotation thereof. The centrifuge interior drum 1304 is contained within a centrifuge outer drum 128. Separated lean material can be inserted into the interior of the centrifuge 1302 and the centrifuge slidable cover 1308 can be closed and the motor 124 can be activated thereby powering the centrifuge to extract any excess water from the lean material. Once the water has been extracted the lean material can be removed from the centrifuge device and conveyed further for future processing. Alternatively, a decanter or screw press or an absorbent material or other type of dryer process can be utilized to remove the water from the product.

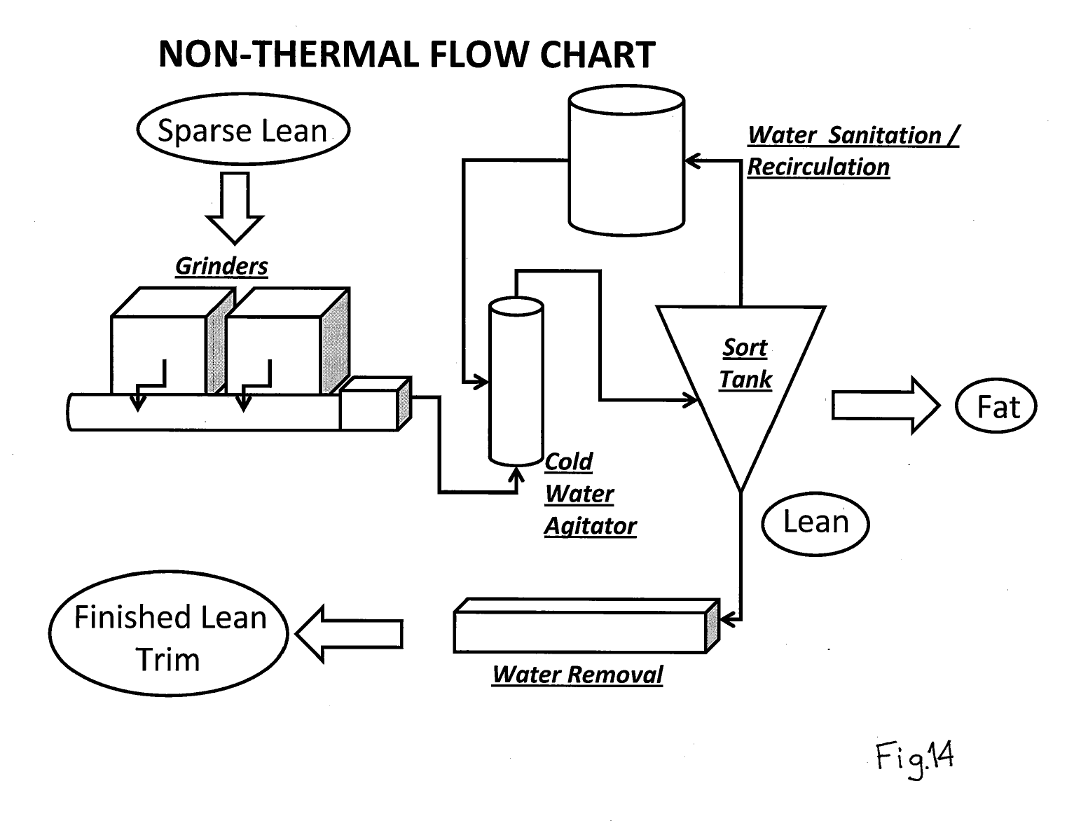

Referring to FIG. 14, an overall non-thermal process flow diagram is shown. The sparse lean product is shown being processed by a size reduction system such as the grinder illustrated in the flow diagram, however other size reduction methods can be used without departing from the scope of the invention. The size reduced sparse lean product is shown being output by the size reduction system and input into an agitator assembly, which can be done by inputting and channeling the sparse lean product down a product chute and into the agitator assembly. The agitator assembly being illustrated in the flow diagram is a cold water agitator. The parse lean product will travel down a chute into the agitator a duct. The parse lean product can be manually deposited in the chute or alternatively the parse lean product can be automatically dropped on the chute by way of a conveyance system. When the parse lean product travels down the product chute into the agitator duct, the parse lean product will encounter an agitator within the duct, which will apply an impact force having sufficient force to separate the lean material portions of the parse lean product from the fatty portions. The agitator duct and surrounding capture vessel can be continuously being filled with water such that the water will overflow the capture vessel into a settling basin.

The agitator can force the product through the agitator duct and into the capture vessel and the continuous water flow from the illustrated Water Sanitation/Recirculation system will cause the separated product to travel along with the overflow of water into the settling basin 110, which is illustrated in the flow diagram as a sort tank. Once in the settling basin or sort tank, as illustrated, the separated lean material portions of the parse lean product will tend to sink toward the bottom of the settling basin which is filled with water. The separated fatty portions of the parse lean product will tend to float toward the top of the water contained within the settling basin. The fatty portion can be skimmed off by the skimming conveyor system or other skimming mechanism, for example a mechanical arm that skims the surface of the water with a sweeping motion. The fat can also or alternatively be allowed to flow thru the overflow channel and dewatered with a similar device as 104 thereby, eliminating the need for a skimming conveyor.

The lean material portion can be conveyed by a conveyor, which can include an auger and an auger screen. Lean material portions can be channeled through an exit port into a water velocity reducer and further directed into the auger and auger screen. Once the lean material portions have been conveyed through the auger, the lean material portions can be captured manually or automatically conveyed to be inserted in the water extraction/removal system as illustrated. The water extraction system can include a centrifuge motor and centrifuge drive belt for turning the interior drum of the centrifuge within the centrifuge outer drum.

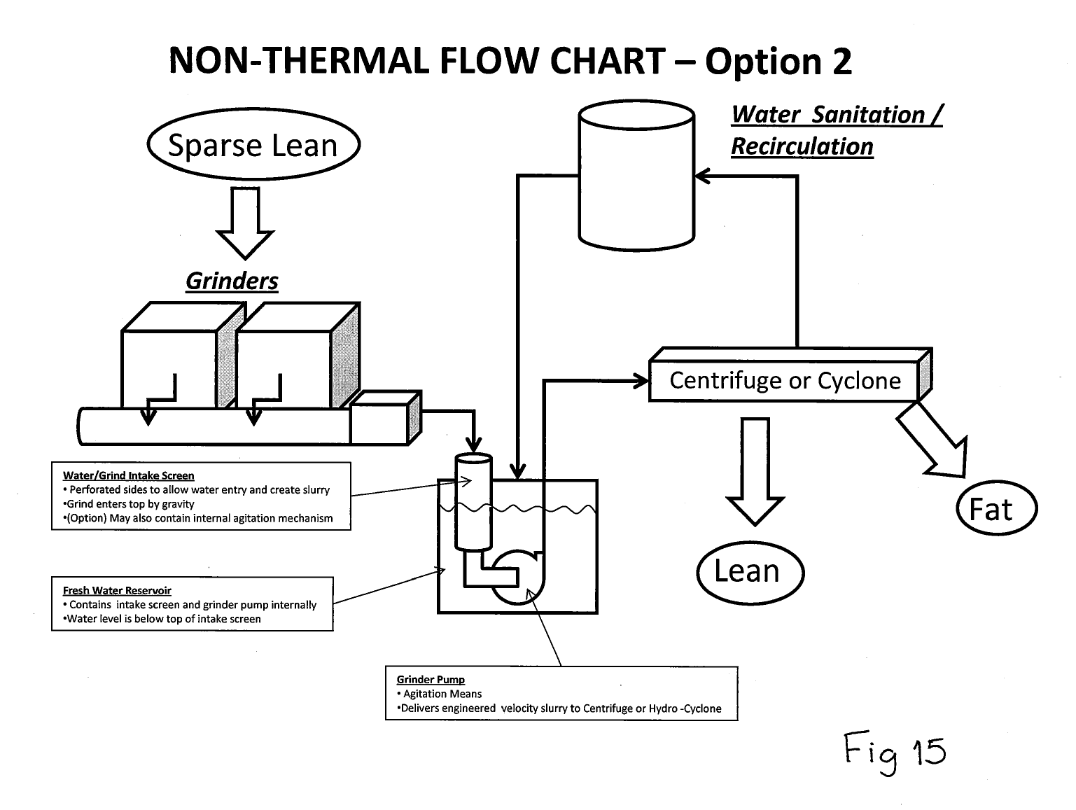

Referring to FIG. 15, an overall non-thermal process flow diagram is shown with an optional grinder pump and centrifuge/cyclone. The grinder pump assembly can be utilized in lieu of the cold water agitator or in series with. If used in series, the cold water agitator would have already separated out a portion of the fat. The grinder pump assembly is illustrated as including a water/grind intake screen container, which is partially submerged in a fresh water reservoir and is operable to receive the reduced sized product. The perforated sides of the screen container allows water to enter the container and mix with the product in order to create a slurry. The reduced size product can enter through the top of the container by gravity. The screen container can also have an internal agitator mechanism for impacting the product to cause separation of fat and lean. The fat will tend to float to the top. The product can flow from the screen container into a grinder pump, which can output an engineered velocity slurry. The slurry can be feed through a centrifuge and/or cyclone for example a hydro-cyclone to separate out the fat and lean. A hydro-cyclone is a device to classify, separate or sort particles in a liquid suspension based the ratio of their centripetal force to fluid resistance. This ratio is high for dense (where separation by density is required) and coarse (where separation by size is required) particles, and low for light and fine particles. Hydro-cyclones also find application in the separation of liquids of different densities. A hydro-cyclone will normally have a cylindrical section at the top where liquid is being fed tangentially, and a conical base. The angle, and hence length of the conical section, plays a role in determining operating characteristics.

A hydro-cyclone has two exits on the axis: the smaller on the bottom for underflow and a larger at the top for overflow. The underflow is generally the denser or coarser fraction, which in this case could be the more lean, while the overflow is the lighter or finer fraction, which in this case could be could be the more fat. Internally, centrifugal force is countered by the resistance of the liquid, with the effect that larger or denser particles are transported to the wall for eventual exit at the reject side with a limited amount of liquid, whilst the finer, or less dense particles, remain in the liquid and exit at the overflow side through a tube extending slightly into the body of the cyclone at the center. Forward hydro-cyclones remove particles that are denser than the surrounding fluid, while reverse hydro-cyclones remove particles that are less dense than the surrounding fluid. In a reverse hydro-cyclone the overflow is at the apex and the underflow at the base.

The various non-destructive lean recovery examples shown above illustrate a novel method and apparatus for recovering lean from trimmings and the like. A user of the present invention may choose any of the above lean recovery embodiments, or an equivalent thereof, depending upon the desired application. In this regard, it is recognized that various forms of the subject non destructive lean recovery apparatus and method could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

What is claimed is:

1. A method for recovery of lean from sparse lean comprising the steps of:
suspending sparse lean in water in a vessel having an agitator within said vessel and adapted to apply agitation forces to said sparse lean where said agitation forces having sufficient impact forces to separate lean material portions from fat portions of the sparse lean;
agitating the sparse lean with the agitator;
flowing the separated lean material portions and the fat portion from the vessel to a settling basin and suspending the lean material portions and the fat portions in water in the settling basin;
allowing the lean material portions to sink below the surface of the water contained in the basin and allowing the fat portions to float toward the top of the water contained in the basin;
skimming off the floating fat portions floating toward the top of the water contained in the settling basin and capturing for further processing; and
removing the lean material portions sunk below the surface of the water contained in the settling basin and capturing for further processing.

2. The method for recovery of lean as recited in claim 1, where the agitator is a rotating propeller blade.

3. The method for recovery of lean as recited in claim 1, where the agitator is a compressed air jet.

4. The method for recovery of lean as recited in claim 1, where the step of skimming is performed by flaps projecting from an endless conveyor and skimming the surface of the water in the settling basin.

5. The method for recovery of lean as recited in claim 1, where the step of removing lean material portions sunk below the surface of the water contained in the settling basis is performed by channeling the lean material portions out an exit port in fluid communication with said settling basin.

6. The method for recovery of lean as recited in claim 1, further comprising the step of removing water from the lean material portions using a centrifuge.

7. The method for recovery of lean as recited in claim 1, where the water in said vessel and in said settling basin is maintained at a temperature from 35 degrees Fahrenheit to 50 degrees Fahrenheit.

8. A system for recovery of lean from a sparse lean comprising:
a vessel having an agitator having moving members and adapted to impact and thereby apply agitation forces to sparse lean suspended within said vessel in water where said agitation forces having sufficient impact forces to separate lean material portions from fat portions of the sparse lean;
a flow port adapted to allow the separated lean material portions and the fat portions to flow out of the vessel;
a settling basin positioned to receive the out flow of the lean material portions and the fat portions from the vessel and said settling basin adapted to suspend said lean material portions and fat portions in water;
a skimmer adapted to traverse and skim the water surface in the settling basin to remove fat portions from the settling basin; and
a capture port in fluid communication with said settling basin and adapted to channel the lean material portions from the settling basin.

9. The system for recovery of lean as recited in claim 8, where said agitator is a powered rotatable propeller blade adapted to apply agitation impact forces sufficient to separate lean material portions from fat portion.

10. The system for recovery of lean as recited in claim 8, where said agitator is a pneumatic compressed air jet.

11. The system for recovery of lean as recited in claim 8, where said skimmer is an endless conveyor belt positioned over the surface of the water in the settling basin having skimming flaps projecting from said conveyor belt where said skimming flaps extend to the surface of the water in the settling basin.

12. The system for recovery of lean as recited in claim 8, where said capture port is an exit port position proximate a lower portion of the settling basin.

13. The system for recovery of lean as recited in claim 8, further comprising a centrifuge positioned to received lean material portions channeled through said exit port.

14. The system for recovery of lean as recited in claim 8, where the water in said vessel and in said settling basin is maintained at a temperature from 35 degrees Fahrenheit to 50 degrees Fahrenheit.

15. A method for recovery of lean from sparse lean comprising the steps of:
impacting a sparse lean product with a force sufficient to separate lean material portion from fatty portions;
suspending the separated lean material portions from the separated fatty portions in water contained in a settling basin and allowing the fatty portion to float toward the surface of the water and allowing the lean material portions to sink toward the bottom of the settling basis;
removing the fatty portions by skimming the surface of the water; and
removing the lean material portions.

16. The method for recovery of lean as recited in claim 15, where impacting the sparse lean product is by impacting with a powered rotatable propeller blade adapted to apply agitation impact forces sufficient to separate lean material portions from fat portion.

17. The method for recovery of lean as recited in claim 16, removing the fatty portions is by skimming with an endless conveyor belt positioned over the surface of the water in the settling basin having skimming flaps projecting from said conveyor belt where said skimming flaps extend to the surface of the water in the settling basin.

18. An apparatus for recovery of lean from a sparse lean comprising:
a ducted motor powered rotatable blade positioned in a capture vessel containing water where when said blade is powered to rotate, sufficient impact forces are exerted by the blade to separate lean material portions of a sparse lean product from fatty portions;
a settling basin containing water position under the capture vessel operable to receive and suspend lean material portions and fatty portions overflowing said capture vessel;
a skimmer adapted to skim the surface of the water in the settling basin for removal of floating fatty portions; and
a discharge pipe in fluid communication with said settling basin and attached proximate a lower portion of said settling basin for receiving lean material portions.

19. The apparatus for recovery of lean as recited in claim 18, where said skimmer is an endless conveyor belt positioned over the surface of the water in the settling basin having skimming flaps projecting from said conveyor belt where said skimming flaps extend to the surface of the water in the settling basin.

20. The apparatus for recovery of lean as recited in claim 19, where the lower portion of the settling basin is a channeling trough extending along a keel of the basin.

21. A method for recovery of lean from sparse lean comprising the steps of:
collecting a lean product in a screen container having perforated sides and submerged in a water reservoir for allowing water to mix with the lean product;
impacting a sparse lean product with a force sufficient to separate lean material portions from fatty portions;
suspending the separated lean material portions from the separated fatty portions in water contained in a screen container and allowing the fatty portion to float toward the surface of the water and allowing the lean material portions to sink toward the bottom of the screen container; and
creating a slurry using a grinder pump and outputting to a hydro-cyclone and separating lean and fat.

22. The method for recovery of lean from sparse lean comprising the steps of:
where impacting the sparse lean product is by impacting with a powered rotatable propeller blade adapted to apply agitation impact forces sufficient to separate lean material portions from fat portion
